(19) United States
(12) Patent Application Publication
(10) Pub. No.: US 2017/0011467 A1
(43) Pub. Date: Jan. 12, 2017

(54) Methods and Apparatus for Remote Collection of Sensor Data for Vehicle Trips with High-Integrity Vehicle Identification

(71) Applicant: Telanon, Inc., Conyers, GA (US)

(72) Inventor: Bennie Lewis Farmer, Conyers, GA (US)

(73) Assignee: Telanon, Inc., Conyers, GA (US)

(21) Appl. No.: 15/068,594

(22) Filed: Mar. 13, 2016

Related U.S. Application Data
(60) Provisional application No. 62/133,309, filed on Mar. 14, 2015.

(51) Int. Cl. G06Q 40/08; H04L 29/08; G07C 5/00

(52) U.S. Cl. CPC G06Q 40/08; G07C 5/008; H04L 67/12

(57) ABSTRACT

The present invention provides methods and apparatus for improved confirmation of the identity of the vehicle whose data are to be captured for any purposes, including usage-based insurance. It can perform this service to improve confidence in certain data captured by stand-alone smartphone applications, as well as for all data captured by stand-alone hardware devices that attach to the vehicle for power but do not electronically confirm VIN from the vehicle.

### CROSS REFERENCE TO RELATED APPLICATIONS

This Application claims priority benefit under 35 U.S.C. 119(e) to U.S. Provisional Application Ser. No. 62/133,309, filed on Mar. 14, 2015, entitled “METHODS AND APPARATUS FOR REMOTE COLLECTION OF SENSOR DATA FOR VEHICLE TRIPS WITH HIGH-INTEGRITY VEHICLE IDENTIFICATION,” which is hereby incorporated by reference in the entirety and made part hereof.

### BACKGROUND

Verifying Vehicle Identification Number (“VIN”) and collecting data regarding vehicle trips is desirable for a number of purposes, such as for use in providing automotive usage-based insurance policies. Such policies base their premiums in part on data captured from the insured vehicle. To rely on such data, the insurers must not only have reliable data—they must also have reliable evidence that the data came from the insured vehicle.

One approach to capturing reliable data and confirming it is for the correct vehicle is to capture data from the vehicle's OBD-II databus. With appropriate commands, a device attached to that databus can for many vehicles query the vehicle's computer modules and memory units and receive messages confirming VIN, speed, in some cases odometer reading, and many other types of data. An example of this approach is the use of an OBD-II module which the consumer plugs into his or her vehicle's OBD-II connector for a usage-based insurance program named Snapshot™ offered by Progressive Casualty Insurance Company. This system uses appropriate commands to receive VIN when available and once-per-second speed data during the vehicle's operation.

By using an OBD-II device to read such data that is attached by the consumer to the vehicle, costs are much lower than required for having a system professionally installed. However, even the costs of the plug-in OBD-II module approach, such as offered by Progressive, for hardware, mailing devices to and from consumers, and associated logistics, are still a barrier to adoption. Plus, that connection raises the concern that malicious software might be introduced through a security breach to issue commands to the vehicle that could compromise safety during its travel.

It would be desirable to have a system to acquire desired vehicle data which involve lower costs than necessary for the OBD-II plug-in device as described above, and also to avoid the requirement for a data connection to the vehicle that could compromise the safety of the vehicle.

There have been developed: 1) an application for the customer's or potential customer's smartphone to capture data without requiring an additional hardware device; and 2) a device that attaches to the vehicle and captures data from its own sensors such as accelerometer and/or GPS, but only attaches to the vehicle to draw power from its battery, rather than to the OBD-II databus to capture data. The drawbacks of these approaches are addressed below.

Stand-Alone Smartphone Application This is an application (“app”) the customer or potential customer downloads and installs on his or her smartphone, which is capable of accessing the smartphone's internal sensors such as accelerometer, magnetic, GPS, and camera, and capturing data from them. Examples are the Telanon™ Test app being developed by Telanon, Inc. for usage-based insurance comparison shopping and Odo-Foto™ being developed by Vehcon, Inc. for capturing odometer and VIN data. Telanon monitors data from the smartphone sensors, and when a vehicle trip is confirmed it records data from selected sensors and transmits that data to Telanon's server applications where it is analyzed for driving and usage-based insurance purposes. According to public data, Odo-Foto uses the smartphone camera to capture images of the instrument panel containing the odometer, so that differences in odometer readings at different times can be used to verify mileage traveled between those times. It also captures images of VIN or scans VIN bar codes, in order to transmit that data along with the image of the instrument panel's odometer reading.

The problem with these and other stand-alone smartphone applications is the difficulty of determining with high integrity the identity of the vehicle whose data are being captured for analysis. Since there is no electronic connection to the vehicle's OBD-II databus, then electronic confirmation of its VIN is not available. Plus, separate images of a vehicle's VIN and its instrument-panel odometer could allow the VIN and odometer images to be taken from different vehicles.

Portable Device with Internal Sensors That Draws Power from Vehicle

This type of device can have internal sensors similar to those in a smartphone, so can use GPS to provide accurate timestamps for both its own data (speed and location) as well as for acceleration data from an accelerometer that may also be present, as well as for other types of data from other sensors. An example of this type of device is the WhiteBox™ developed by Swedish company Movelo. It plugs into a vehicle's cigarette-lighter outlet for power, but does not attach to the vehicle data bus. One of its advantages versus devices that plug into the OBD-II databus connector is that it is a less expensive design to manufacturer. An important disadvantage, however, is that unlike OBD-II plug-in devices, it cannot by itself confirm the identity of the vehicle to which it is attached for power. So although in some vehicles it can detect interruption of power that would likely happen if it were moved from the correct vehicle to another one, it cannot by itself tell whether it was initially connected to the correct vehicle. Further, many vehicles do not provide continuous electrical power to their cigarette-lighter or similar power outlets. In that case, it is very difficult to determine when a device plugged into such power source is moved when no power is present.

Besides the difficulty of identifying a vehicle with high integrity without a data connection to its OBDII databus, current approaches are limited to collecting only data from the vehicle's available sensors or from GPS, accelerometer, gyrometer, or other such sensors commonly found in smartphones. These types of data only describe the motions and sometimes locations of the vehicle. It would be desirable to provide data about vehicles and objects in front and beside the vehicle, because this information provides better insights into driving behavior and decisions than simply motion and location data.

These types of data can be provided by outward-looking sensors such as radar, cameras, and lasers or LIDAR units. Such sensors are now being used for self-driving vehicle development by Google and others, but are not yet installed on many production vehicles either at the factory on new vehicles or as aftermarket units on existing vehicles. One issue is the traditional cost of such products, especially radar sensors like used by Eaton VORAD Technologies, LLC starting in 1998 for its EVT-300 product for heavy vehicles. The advantages of that system were well known by Eaton VORAD and its truck fleet customers, but its cost was a barrier to wider adoption.

### DESCRIPTION OF INVENTION

To overcome these problems, the following invention provides methods and apparatus for improved confirmation of the identity of the vehicle whose data are to be captured for any purposes, including usage-based insurance. It can perform this service to improve confidence in certain data captured by stand-alone smartphone applications, as well as for all data captured by stand-alone hardware devices that attach to the vehicle for power but do not electronically confirm VIN from the vehicle.

The following is an example of the implementation of this invention at this time, but additional embodiments of the same invention are possible and contemplated.

This invention utilizes a Vehicle Identifier unit that is semi-permanently attached to a vehicle's windshield, with a power line run to the nearest in-vehicle fuse box to supply it power. Its location on the windshield will be optimized so that one or more forward-looking sensors that will be incorporated into it, or designed into modules to attach to it, provide data relating to vehicles and other objects ahead of or beside the vehicle. Possible positions are the center, either near the top or bottom of the windshield, or at the drivers-side edge of the windshield near its top or bottom.

The unit may be designed to attach to the windshield using high-strength adhesive so that it will not accidentally detach during normal vehicle use, but can be scraped off if the vehicle owner no longer wants it attached. It will be designed to make obvious if it has been removed from the windshield where it was first installed, even if some type of adhesive is used to re-attach it afterwards to the same or another windshield. Alternatively, the unit may be attached at another suitable location on the vehicle. This will allow physical inspection by a person, such as an agent of the vehicle's insurance company, to determine if the unit on a vehicle after an accident was originally installed on the windshield of that same vehicle. In the case that an accident occurs and the insurer's representative determines that the correct Vehicle Identifier unit is not attached to the insured vehicle's windshield, or that it is present but displays evidence it was removed and re-attached, then that insurer may choose to reduce payment on its claim for that accident or even refuse payment for the claim altogether.

The electrical power supplied to the Vehicle Identifier unit will come from the vehicle's own power, typically 12-volt or 24-volt, with the anticipated approach being from the nearest in-vehicle fuse box using a plug-in device similar to commercially-available products named Add-A-Circuit or Add-A-Fuse. They simply replace an existing fuse in a circuit with desirable characteristics, and also provide wires with power for an additional circuit that can power the Vehicle Identifier.

Other suitable connections to the vehicles power supply may be used, or alternatively, the unit could be powered by a battery power supply if desired. If needed, the vehicle's power will be converted to an appropriate voltage, such as 5 volts or other value, for use by the Vehicle Identifier unit's electronic circuits, before being transmitted through wires to the Vehicle Identifier unit. Those wires will be designed so they can be concealed along the path from the fuse box to the Vehicle Identifier unit, for more attractive appearance.

The Vehicle Identifier unit will have a processor with embedded software to control its operation. In an example, the Vehicle Identifier unit may also have at least one sensor, such as an accelerometer to detect motion, and a wireless radio to communicate data without requiring physical attachment to another device. In an example, the Vehicle Identifier unit will contain both Classic Bluetooth and Bluetooth Low Energy radios, for communication to smartphones containing Bluetooth radios, so that data can be communicated between the Vehicle Identifier unit and those smartphones that are within range to receive the Bluetooth signals and having appropriate software applications to interpret them. An alternative configuration could have a cellular wireless radio to communicate data directly to nearby cellular towers, a hardwired connection to a processor on-board the vehicle or another suitable alternative. To improve integrity of data that is communicated, it can be encrypted before transmission from the Vehicle Identifier and decrypted after reception by an appropriate software application running at the intended destination. Also, to improve integrity of data that is communicated, the Vehicle Identifier can have stored a unique identifier associated with that particular Vehicle Identifier unit, which is communicated along with other data from it to its intended destination, where it can be compared with similar identifiers that have been previously collected from Vehicle Identifier units believed to be genuine units and not from other sources. These two approaches used in combination, unique identifiers transmitted with other data and using encrypted communications, can together provide authentication of a genuine Vehicle Identifier unit and also guard against attempts to intercept and interpret data contained in those communications that could allow false data to be communicated in attempts to compromise the security and privacy of data being communicated.

To improve the confidence in trip data captured by sensors in an associated smartphone application communicating with the Vehicle Identifier unit or by sensors in the Vehicle Identifier unit itself or a module attached to it, data from sensors such as an accelerometer within the Vehicle Identifier unit will be used by embedded software in its processor to detect two types of useful situations.

First, the beginning and end of every trip can be detected, so that every trip that is taken while the Vehicle Identifier is properly powered is identified and relevant data about the trip is captured for analysis later. Such data can be the elapsed time of the trip, accelerations experienced during the trip, and/or date and time of trip start and finish. If the Vehicle Identifier contains appropriate sensors to directly detect speed, such as a GPS unit, then speeds may be captured at appropriate intervals, such as once per second, for each trip also.

Second, if the Vehicle Identifier unit is constantly powered, then the loss of that power can be detected and the date and time recorded in persistent memory contained in the Vehicle Identifier unit for later analysis. The re-acquisition of that power can also be detected, and the date and time stored similarly. This is an approach already used by devices such as the Snapshot OBD2 plug-in unit provided by Progressive Casualty Insurance Company to its customers for usage-based automotive insurance purposes. By analyzing the amount of time that a recording unit is not powered, an evaluation of confidence level can be made that a sufficient percentage of total trips are being captured by the device, so that price discounts based on the trips recorded will be offered.

Because of the advantages of having the Vehicle Identifier unit constantly powered, it is an advantage to design its circuits to require the minimum amount of power so that the battery providing the power loses as little of its charge as possible. This is true whether it is the host vehicle's battery, with power provided through a connection to a circuit in a fuse box or another approach, or whether it is a battery built into the Vehicle Identifier itself In order to minimize battery drain, it is possible to design the Vehicle Identifier circuits so that until the beginning of a vehicle trip is identified, only the circuits necessary for tamper detection and trip detection will be fully powered. The other circuits can be designed to receive little to no power in that state. Then, when the start of a trip is detected, those circuits can be fully powered so that they operate correctly during the trip, and once the end of the trip is detected, they can return to their state drawing little to no power again.

In an example, when the Vehicle Identifier unit is installed, it will communicate with an appropriate smartphone or other suitable device with a processing system, running a software application designed to recognize it. When recognized, the software will allow the vehicle identification number, or VIN, to be entered, and will transmit it to the Vehicle Identifier unit, and it will be stored within that unit. Alternatively, the Vehicle Identifier unit could allow direct input of the identifying information. The unit and the smartphone software will also verify that the unit has been successfully attached to a windshield, such as by detecting that the unit was attached, is not moving, and is powered, or in another suitable manner. For example, the attachment system itself could include a switch or other device that will positively indicate the unit is attached to the vehicle. The smartphone software will also communicate the successful installation, along with the Vehicle Identifier's unique serial number and the VIN of the vehicle where it was installed, through a wireless connection to the Internet, and to a server application designed to accept and store that information.

The Vehicle Identifier may also either contain one or more outward-looking sensors to monitor vehicles and other objects ahead and/or beside the vehicle, be designed to accept add-on modules with such sensors, or otherwise be provided with at least one sensor in any suitable manner. In an example, modules with different sensors may be provided, to be easily attached and detached, leaving the Vehicle Identifier unit attached to the vehicle and still powered. Such modules can contain outward-looking sensors using radar, camera, or other sensors, so that data about vehicles and other objects ahead and/or beside the vehicle can be monitored during trips by the vehicle. As an example, silicon germanium and CMOS semiconductor devices have recently been developed to allow radar to operate at 60 GHz or 77 GHz frequencies and in high-volume production will be very inexpensive. These frequencies are both feasible for use in outward-looking sensors to detect and collect data from vehicles and other objects ahead or beside the host vehicle. Such a sensor at either of those frequencies can use a very small antenna to create a desirable beam shape for effectively monitoring the environment ahead or beside the host vehicle. The data they can retrieve include distance, relative speed, and angular position relative to the center of the radar beam. Once a vehicle or other object of interest is identified, software can track its movement, and that data can be captured for analysis of driving behavior. As learned with much more expensive radar systems deploying older technology, such as the Eaton VORAD EVT-300 for heavy vehicles, data captured by such radar sensors reveal much better insights into the host vehicle driver's behavior, whether risky or safe, than is possible using only data about the motion of the host vehicle. As a result, when properly captured and analyzed, this type of data is valuable to the host vehicle's insurer in accurately assessing the safe or unsafe driving of the host vehicle, in order to determine a potential discount for a usage-based auto insurance policy, or to analyze the cause of an accident by examining the data after the accident occurs.

Such modules in an example may be custom-designed to meet a particular company's requirements, such as Progressive Casualty Insurance Company, for its current Snapshot usage based auto insurance program. In that case, besides containing outward-looking sensors, it could also contain other sensors to collect motion and/or location data. It could also be designed to provide audible and/or visual feedback to the vehicle's driver during trips, consistent with the approach determined by the company for example. Progressive's current Snapshot device is a plug-in unit that attaches to the OBD2 port in vehicles, and can provide audible alerts when various driving metrics are met that Progressive considers indicators of risky driving. In a similar way, alerts based on the same or other metrics could be provided by the invention, and different modules may be used by different companies for example.

In an example, for installation of the Vehicle Identifier unit and a module providing data for a particular automobile insurer's usage based insurance program, the insurer could have customers take their vehicles to a facility where they authorize repairs to insured vehicles after accidents. There, the Vehicle Identifier could be quickly and professionally installed, along with an additional module designed to that insurer's specifications.

An advantage of this invention is that after an insurer has received all the vehicle trip data it wants from a particular vehicle, the additional module meeting that insurer's requirements can be easily removed by the customer and returned. The Vehicle Identifier unit will remain in position, and can receive a module to provide information required by a new insurer, or a module selected by the customer to provide data and services he or she chooses. For example, the at least one sensor could be used to detect objects in front of or to the side of the vehicle and issue alerts to provide the driver with information to maintain safety and avoid an accident. In another example, the at least one sensor could be used to detect objects in front of or to the side of the vehicle, the module or Vehicle Identified unit could store data related to them, and based on identifying an event of risky driving behavior or other potential cause of accident, could cause data at and near the time of that identified event to be stored for use later in reviewing and/or analyzing that event.

Alternatively, a general-purpose module or the Vehicle Identifier itself could be designed to support many different uses, including customized requirement by multiple insurers for their usage based automobile insurance products. A common hardware design could be supplemented with software that is used to give the particular operation and potential audible and/or visual feedback to the driver desired by an insurer during vehicle trips. In that case, a preferred embodiment would display the name and usage based insurance brand of the insurer, to positively confirm to the driver and owner of the vehicle which insurer and product are active at any given time.

### BRIEF DESCRIPTION OF THE DRAWING

Other objects and advantages of the invention will become apparent upon reading the description of embodiments thereof, in conjunction with the drawing.

FIG. 1 is a schematic diagram of the system according to an embodiment of the present invention.

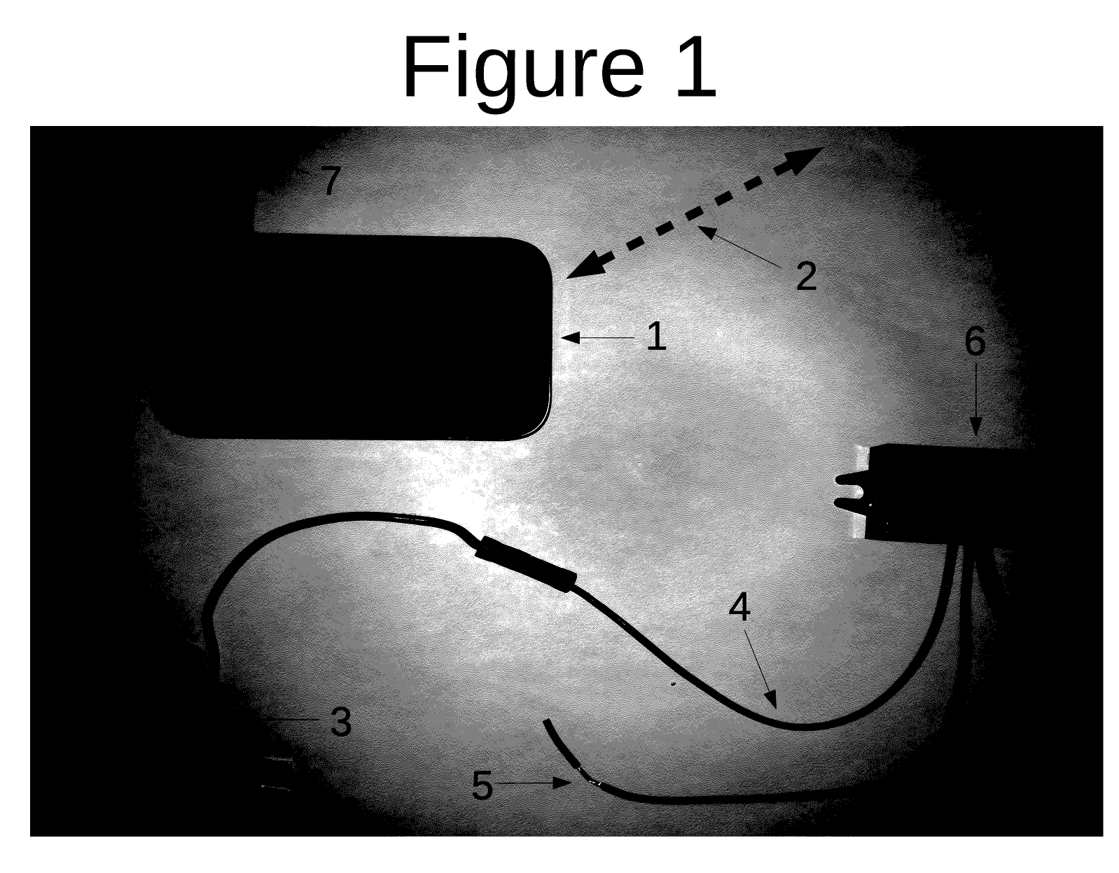

A Vehicle Identifier Unit 1 is shown, which can be semi-permanently attached in an appropriate position in the vehicle so that its sensors and sensors of any modules that can be attached to it will operate properly. It can have tamper detection circuitry and logic to detect and store evidence if any attempts are made to remove it. It can also show physical evidence if it is removed from the original place it is attached, so that a person can determine by visual inspection that it was removed from its original mounting location. It can also contain an accelerometer to detect motion, a processing unit with embedded software to perform all desired operations, and memory for storing data until it is needed. When desired, the data can be encrypted and wirelessly communicated, using Classic Bluetooth or Bluetooth Low Energy short-range radio signals as shown by dashed arrow 2 along with a unique identifier for that particular Vehicle Identifier Unit 1, to a smartphone (not shown in FIG. 1) with similar Bluetooth radio and appropriate software to receive that data, where it can be decrypted and authenticated as coming from a genuine Vehicle Identifier Unit 1. From there, it can be communicated when possible by the software on the smartphone over a wireless Internet connection to a server where an appropriate server application can receive and store it for further analysis. For that communication, an encrypted SSL wireless link can be used to preserve high integrity of the data being communicated, as well known and practiced for many other Internet data communications that require improved security.

To power the Vehicle Identifier Unit 1, a commercially-available Add-a-Circuit or similar device 3 can be used to replace a fuse in an always-powered circuit in a nearby fuse box in the host vehicle, typically within the passenger compartment and concealed behind a panel near the driver's or passenger's door. The replaced fuse can be inserted into that device 3, a second fuse can be added to protect the new circuit being created to power the Vehicle Identifier Unit 1, and the device 3 can be plugged into the position where the replaced fuse had originally been located. The red power line coming from unit 3 has a connector that can be crimped onto the end of a red power line 4 attached to a commercially-available voltage converter 6, to provide a good power connection. The black ground line 5 coming from voltage converter 6 can be attached to a suitable vehicle ground near the fuse box, typically by being attached to a metal washer that is placed between a metal bolt that mounts into the vehicle's metal frame. Finally, the vehicle power conducted from device 3 through the positive line 4 into voltage converter 6 can be converted into the voltage suitable for the Vehicle Identifier unit 1. That current is provided to Vehicle Identifier unit 1 through power line 7, which can be placed behind edges of the vehicle's interior to conceal it. The result is that except for a short length of power line 7 that can be seen entering Vehicle Identifier unit 1, nothing else about the product may be visible without accessing the concealed fuse box.

Based on the foregoing disclosure, the system and methods of the invention can capture and confirm the identity of the vehicle and capture and communicate data about the vehicle and/or driving characteristics, for any purpose, such as for usage-based insurance. The systems and methods may be used to improve confidence in certain data captured by stand-alone smartphone applications, as well as for all data captured by stand-alone hardware devices that attach to the vehicle for power but do not electronically confirm VIN from the vehicle. It is therefore to be understood that the invention encompasses any variations evident for use to accomplish the objectives of the invention, and fall within the scope of the invention herein disclosed and described.

What is claimed is:

1. A system for confirming vehicle identification, comprising
a housing having an attachment system for attaching to a vehicle,
a processor programmed to accept vehicle identification information when attached to a vehicle, and
a communication system that communicates information regarding the identification of the vehicle to at least one other processing system.

2. The system of claim 1, further comprising
at least one sensor that provides information on at least one of the controlled state of the vehicle, an action of an operator, and the environment around the vehicle during operation.

3. The system of claim 2, wherein the at least one sensor is provided in a module that is attachable to the housing.

4. The system of claim 1, wherein the communication system is a wireless communication system.

5. The system of claim 1, wherein the state of attachment of the attachment system to the vehicle is verifiable.

6. A system for confirming vehicle identification, comprising
a vehicle identifier unit including a housing having an attachment system for attaching to a vehicle,
the unit having a processor programmed to accept vehicle identification information when attached to a vehicle, and at least one sensor connected to the processor to detect motion of the vehicle, and
a communication system that communicates information regarding the identification of the vehicle to at least one other processing system so that data can be communicated between the vehicle identifier unit and the other processing system when vehicle motion is detected.
